(19) United States
(12) Patent Application Publication
(10) Pub. No.: US 2009/0213585 A1
(43) Pub. Date: Aug. 27, 2009

(54) LIGHT EMITTING DIODE DISPLAY DEVICE

(75) Inventors: JYH-LONG CHERN, Chu-Nan (TW); JIA-JIN TU, Chu-Nan (TW); CHIEN-LIANG YEH, Chu-Nan (TW); CHUN-WEI WANG, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/192,374

(22) Filed: Aug. 15, 2008

(30) Foreign Application Priority Data
Feb. 22, 2008 (CN) 200810300390.9

(51) Int. Cl. F21V 5/04

(52) U.S. Cl. 362/231

(57) ABSTRACT

A light emitting diode display device includes a circuit board and a plurality of pixel units. Each pixel unit includes a light emitting diode assembly positioned on and electrically connected to the circuit board, and a light-mixed component positioned on a side of the light emitting diode assembly configured for mixing lights emitted from the light emitting diode assembly to generate a mixed light beam.

### BACKGROUND

1. Field of the Invention

The present invention generally relates to display devices and, particularly, to a light emitting diode display device with excellent display effect.

2. Description of Related Art

Light emitting diodes (LEDs) have excellent characteristics, for example, small volume, good optical properties, low energy consumption, and long lifespan, which make them very suitable for being used as a light source. With the improvement of light emitting efficiency, LEDs are widely employed as light sources in display devices.

Some LED display devices include a plurality of pixel units that are arranged in rows and lines forming array. Each pixel unit includes a red LED emitting red light, a green LED emitting green light, and a blue LED emitting blue light. However, lights emitted from the red, green, and blue LEDs do not mix well with each other resulting in a lower efficiency of the LED display devices.

Therefore, a new LED display device is desired in order to overcome the above-described shortcoming.

### SUMMARY

An exemplary embodiment of the present invention provides a LED display device including a circuit board and a plurality of pixel units. Each of the pixel units includes a light emitting diode assembly positioned on and electrically connected to the circuit board, and a light-mixed component positioned on a side of the light emitting diode assembly configured for mixing lights emitted from the light emitting diode assembly to generate a mixed light beam.

Other advantages and novel features will become more apparent from the following detailed description when taken in conjunction with the accompanying drawings.

### BRIEF DESCRIPTION OF THE DRAWINGS

Many aspects of the LED display device can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of a first embodiment of a LED display device.

FIG. 2 is an exploded, partial cross-sectional view of the LED display device of FIG. 1.

FIG. 3 is an exploded, partial cross-sectional view of a second embodiment of a LED display device.

FIG. 4 is an exploded, partial cross-sectional view of a third embodiment of a LED display device.

FIG. 5 is an exploded, partial cross-sectional view of a fourth embodiment of a LED display device.

FIG. 6 is a perspective view of a lens array of the LED display device of FIG. 5;

FIG. 7 is an exploded, partial cross-sectional view of a fifth embodiment of a LED display device.

FIG. 8 is an exploded, partial cross-sectional view of a sixth embodiment of a LED display device.

### DETAILED DESCRIPTION OF THE EMBODIMENTS

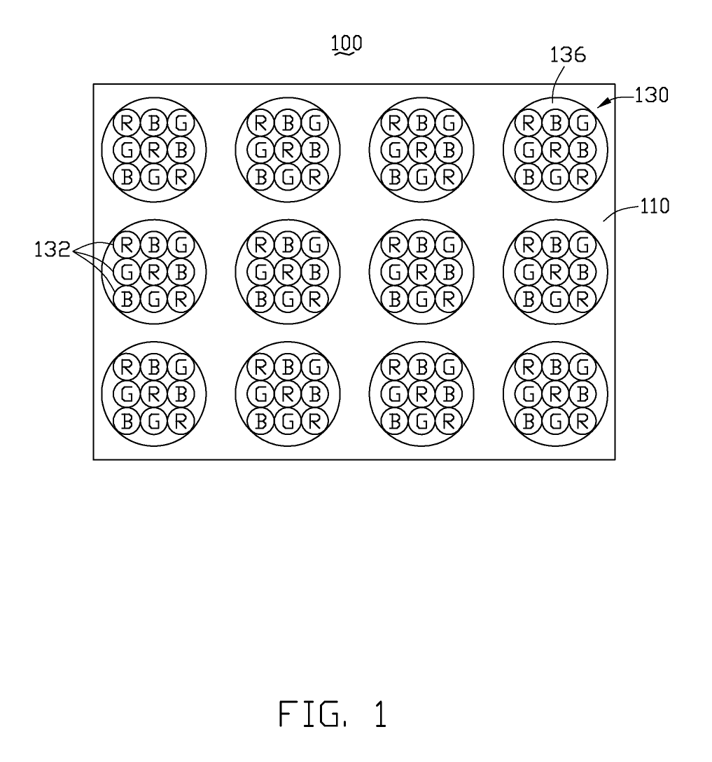

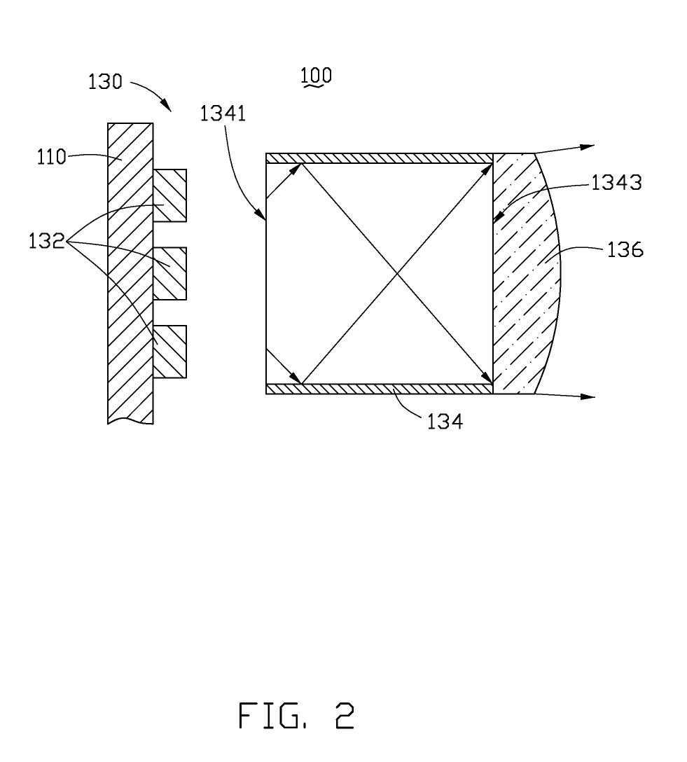

Referring to FIG. 1 and FIG. 2, a first embodiment of a LED display device 100 includes a circuit board 110 and a plurality of pixel units 130. Each pixel unit 130 includes a LED assembly 132 secured on and electrically connected to the circuit board 110, a light-mixed component 134 positioned adjacent to the LED assembly 132, and a light-modified component 136 positioned on a side of the light-mixed component 134.

The LED assembly 132 of each of the pixel units 130 includes at least one red LED capable of emitting red light, at least one green LED capable of emitting green light, and at least one blue LED capable of emitting blue light. Each LED includes a LED chip and a packaging member that encloses the LED chip.

The light-mixed component 134 is configured for mixing lights emitted from the LED assembly 132 to generate a mixed light beam. In the first embodiment, the light-mixed component 134 may be circular, square, or hexagon shaped. The light-mixed component 134 has a reflective inner surface (not labeled), a light input face 1341, and a light output face 1343 opposite and parallel to the light input face 1341. The light input face 1341 is positioned adjacent to the LED assembly 132.

The light-modified component 136 may be a focusing lens and is configured for modifying optical paths of mixed light beams by focusing the mixed light beam emitted from the light-mixed component 134. The focusing lens 136 is attached to the light output face 1343, for example, by index matching glue (not shown).

Lights from the LED assembly 132 are emitted into the light-mixed component 134 via the light input face 1341. Different colored emitted lights are internally reflected in the light-mixed component 134 and mixed into the mixed light beam. The mixed light beam is focused by the light-modified component 136 to reduce the cross-sectional area and the interference between two adjacent pixel units 130, thereby increasing the resolution of the LED display device 100.

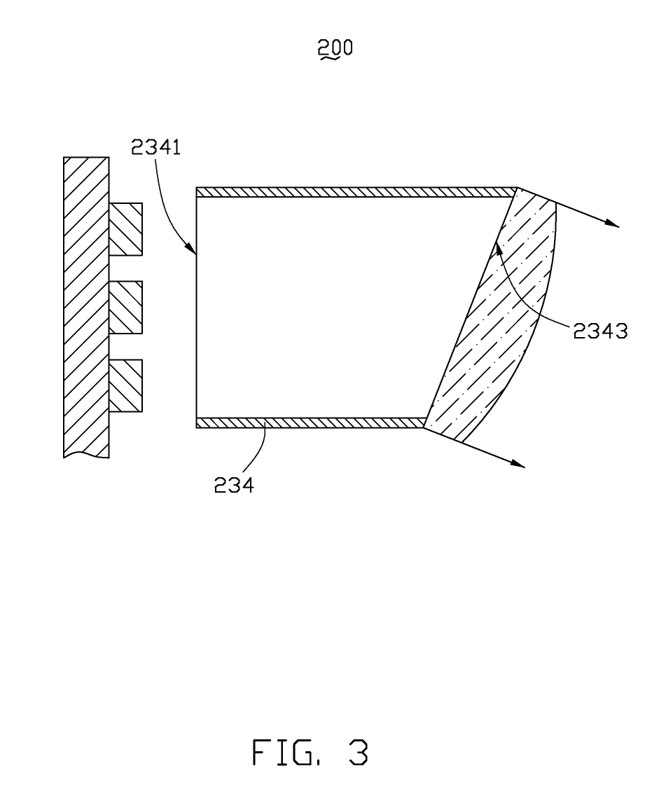

Referring to FIG. 3, a second embodiment of a LED display device 200 is similar to the LED display device 100 of FIG. 2, except that a light-mixed component 234 has a light input face 2341 and a light output face 2343 opposite and forming an oblique angle with the light input face 2341. The light output face 2343 is slanted at an angle for refracting a mixed light beam towards a central portion of the LED display device 200, in order to avoid lights emitting beyond the visual angle of a user.

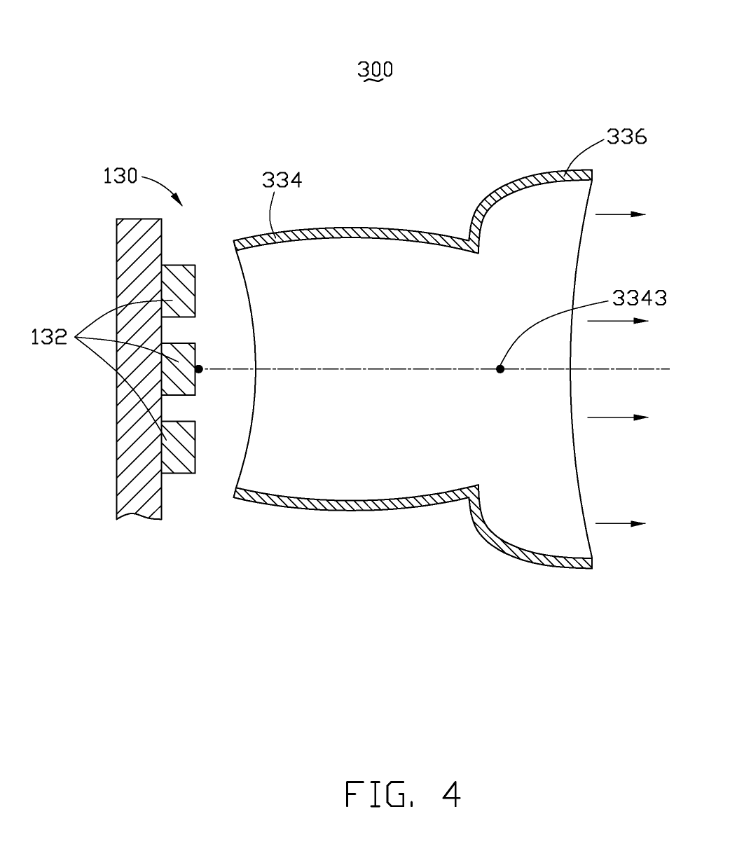

Referring to FIG. 4, a third embodiment of a LED display device 300 is similar to the LED display 100 of FIG. 2, except that a light-mixed component 334 includes an elliptical wall (not labeled), a first focus point 3341, and a second focus point 3343, the LED assembly 132 is positioned at the first focus point 3341, and a light-modified component 336 includes a paraboloidal wall (not labeled) and a third focus point (not labeled) overlapping the second focus point 3343. The light-modified component 336 may be integrally formed with the light-mixed component 334.

Lights emitted from the LED assembly 132 are internally reflected in the elliptical light-mixed component 334 and mixed into a mixed light beam. The mixed light beam is focused on the second focus point 3343 and the third focus point and changed into parallel light beams by the paraboloidal light-modified component 336 to reduce the cross-sectional area and to avoid lights emitted beyond the visual angle of a user. The interference between two adjacent pixel units 130 is reduced and the resolution of the LED display device 300 is increased.

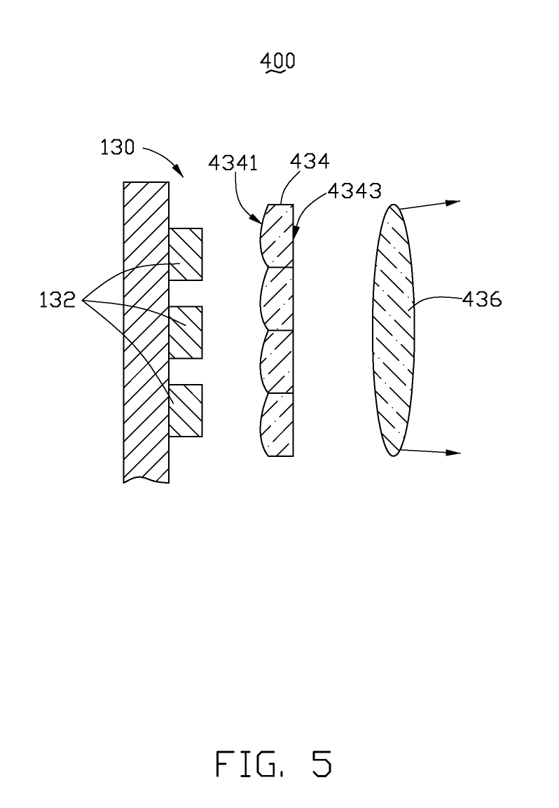

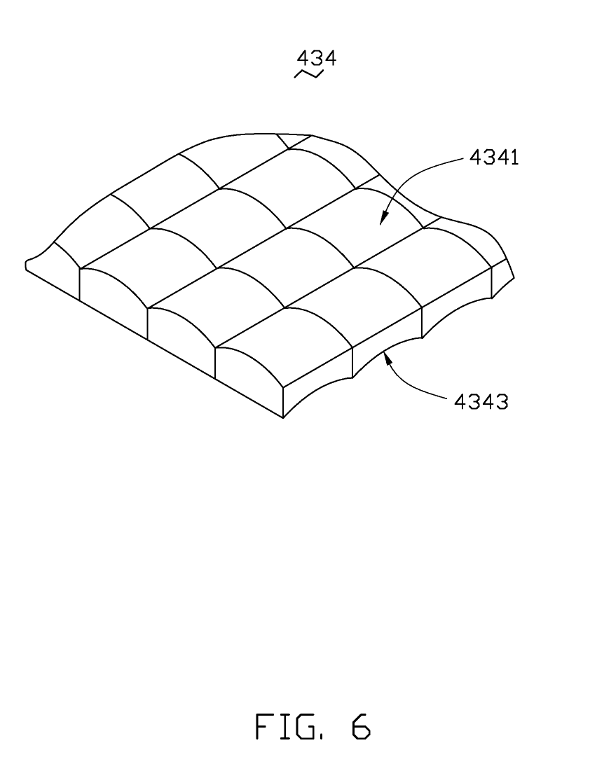

Referring to FIG. 5 and FIG. 6, a fourth embodiment of a LED display device 400 is similar to the LED display device 100 of FIG. 2, except that the light-mixed component 434 may be a lens array formed by a plurality of micro-lenses and the light-modified component 436 may be a biconvex lens.

Each micro-lens includes a light input face 4341 and a light output face 4343. Each micro-lens may be a concave-convex bicylindrical lens, a biconvex bicylindrical lens, or a planar-convex cylindrical lens. The light-mixed component 434 is positioned between the light-modified component 436 and the LED assembly 132, with each light input face 4341 facing the LED assembly 132.

Lights from the LED assembly 132 are emitted into the light-mixed component 434 via the input face 4341 and focused and mixed by each micro-lens to generate a mixed light beam. The mixed light beam is focused by the light-modified component 436 to reduce the cross-sectional area. The interference between two adjacent pixel units 130 is reduced and the resolution of the LED display device 400 is increased.

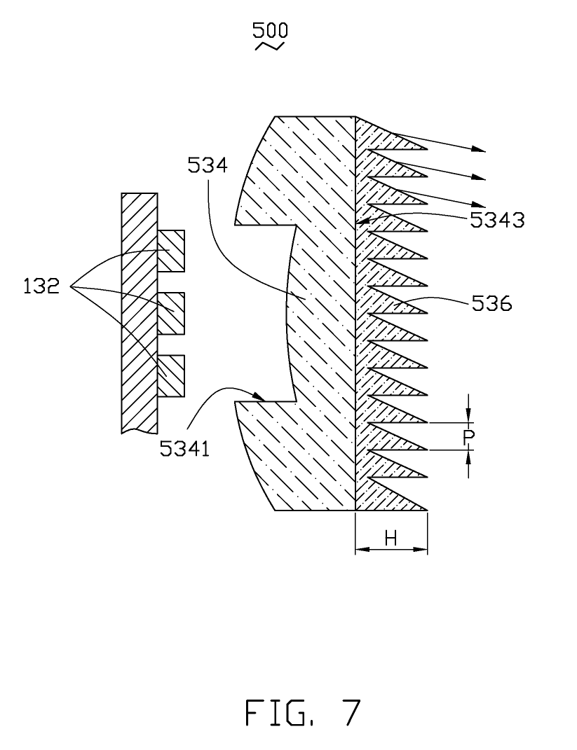

Referring to FIG. 7, a fifth embodiment of a LED display device 500 is similar to the LED display device 100 of FIG. 2, except that the light-mixed component 534 may be a total internal reflection lens and the light-modified component 536 may be a microstructure array formed by a plurality of microstructures.

The light-mixed component 534 includes a light input face 5341 and a light output face 5343. The light-mixed component 534 is positioned between the light-modified component 536 and the LED assembly 132, with the light input face 5341 facing the LED assembly 132.

The light-modified component 536 is positioned on the light output face 5343. Each microstructure is right-triangular shaped and has a height H, less than 300 micrometers. A distance P between the tips of a pair of adjacent microstructures is less than 400 micrometers.

Lights from the LED assembly 132 are emitted to the light-mixed component 534 via the input face 5341, collected, and mixed to generate a mixed light beam. The mixed light beam is refracted towards the central portion of the LED display device 500 by the microstructure array, which avoids lights emitting beyond the visual angle of a user.

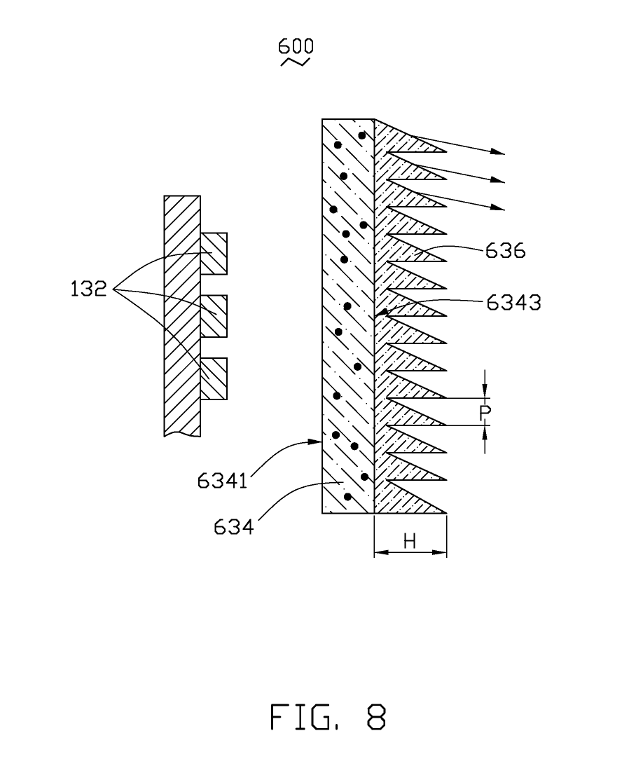

Referring to FIG. 8, a sixth embodiment of a LED display device 600 is similar to the LED display device 500 of FIG. 7, except that the light-mixed component 634 is transparent and distributed with light diffusion particles forming a light diffusion board. The light diffusion board is substantially rectangular shaped and includes a light input face 6341 and a light output face 6343. The light input face 6341 faces the LED assembly 132 and may have a rough surface for diffusing lights emitting from the LED assembly 132. The light-diffusing board 634 may be made of transparent materials with a refractive index more than 1.4, for example, polycarbonate (PC), polymethylmethacrylate (PMMA) or glass. The light diffusion particles have a diameter less than 500 micrometers and may be made of a transparent material, for example, titanium dioxide (TiO₂), PC, PMMA, fused silica, alumina (Al₂O₃) or magnesium oxide (MgO).

The microstructure array 636 is identical to the microstructure array 536 of FIG. 7.

Light from the LED assembly 132 is emitted to the light-diffusing board 634 via the light input face 6341, diffused, and mixed by the light diffusion board 634 to generate a mixed light beam. The mixed light beam is refracted towards the central portion of the LED display device 600 by the microstructure array 636 to avoid lights emitting beyond the visual angle of a user.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. A light emitting diode display device comprising:
A circuit board; and
a plurality of pixel units, wherein each pixel unit comprises a light emitting diode assembly positioned on and electrically connected to the circuit board, and a light-mixed component positioned on a side of the light emitting diode assembly configured for mixing lights emitted from the light emitting diode assembly to generate a mixed light beam.

2. The light emitting diode display device of claim 1, wherein each pixel unit further comprises a light-modified component positioned on a side of the light-mixed component configured for modifying optical paths of the mixed light beam.

3. The light emitting diode display device of claim 1, wherein the light-mixed component comprises a reflective inner surface, a light input face, and a light output face opposite and parallel to the light input face; the light input face is positioned adjacent to the light emitting diode assembly.

4. The light emitting diode display device of claim 3, wherein each pixel unit further comprises a focusing lens positioned on a side of the light-mixed component configured for focusing the mixed light beam.

5. The light emitting diode display device of claim 4, wherein the focusing lens is attached to the light output face using refractive index matching glue.

6. The light emitting diode display device of claim 1, wherein the light-mixed component comprises a reflective inner surface, a light input face and a light output face opposite and forming an oblique angle with the light input face.

7. The light emitting diode display device of claim 1, wherein the light-mixed component comprises an elliptical wall and a first focus point; the light emitting diode assembly is positioned at the first focus point.

8. The light emitting diode display device of claim 7, wherein each pixel unit further comprises a light-modified component positioned on a side of the light-mixed component; the light-modified component includes a paraboloidal wall and a third focus point; the light-mixed component includes a second focus point that overlaps the third focus.

9. The light emitting diode display device of claim 1, wherein the light-mixed component is a lens array that comprises a plurality of micro-lenses.

10. The light emitting diode display device of claim 9, wherein each micro-lens is a concave-convex bicylindrical lens, a biconvex bicylindrical lens, or a planar-convex cylindrical lens.

11. The light emitting diode display device of claim 9, wherein each pixel unit further comprises a biconvex lens positioned on a side of the lens array.

12. The light emitting diode display device of claim 1, wherein the light-mixed component is a total internal reflection lens.

13. The light emitting diode display device of claim 12, wherein each pixel unit further comprises a microstructure array that is positioned on a side of the total internal reflection lens, the microstructure array includes a plurality of microstructures formed in shapes of right-triangle.

14. The light emitting diode display device of claim 13, wherein each microstructure has a height less than 300 micrometers; a distance between the tips of a pair of adjacent microstructures is less than 400 micrometers.

15. The light emitting diode display device of claim 1, wherein the light-mixed component is a light diffusion board that is made of a transparent material with a refractive index more than 1.4.

16. The light emitting diode display device of claim 15, wherein the light diffusion board is distributed with light diffusion particles.

17. The light emitting diode display device of claim 16, wherein the light diffusion particles are made of transparent material and have a diameter less than 500 micrometers.

18. The light emitting diode display device of claim 15, wherein the light diffusion board comprises a light input face which has a rough surface for diffusing lights emitted from the light emitting diode assembly.

19. The light emitting diode display device of claim 15, wherein each pixel unit further comprises a plurality of microstructures positioned on a side of the light-diffusing board; each microstructure is right-triangular shaped.

20. The light emitting diode display device of claim 19, wherein each microstructure has a height less than 300 micrometers; a distance between the tips of a pair of adjacent microstructures is less than 400 micrometers.
